(19) United States
(12) Patent Application Publication
(10) Pub. No.: US 2017/0051771 A1
(43) Pub. Date: Feb. 23, 2017

(54) Furniture and Shelving System

(71) Applicant: Robert Andrew Feinstein, Asbury Park, NJ (US)

(72) Inventor: Robert Andrew Feinstein, Asbury Park, NJ (US)

(21) Appl. No.: 14/829,748

(22) Filed: Aug. 19, 2015

(51) Int. Cl. F16B 12/44; A47B 47/00; A47B 96/02; A47B 13/00

(52) U.S. Cl. CPC F16B 12/44; A47B 13/003; A47B 47/0075; A47B 96/024

(57) ABSTRACT

Furniture and shelving system employing new joint hardware including various embodiments ranging from shelving which may include one of several coat hook designs, boxes, or tables. The particular shelf or furniture embodiment includes at least one wood panel having pre-determined dimensions and thickness. The wood panels are attached together, or to a wall, employing the joint hardware of this invention which includes a pair of metal plates which are nearly, but not perfectly, parallel to each other. The plates are separated by a predetermined distance which distance corresponds to the predetermined thickness of the wood panel(s). The joint hardware of this invention is provided in one of several embodiments including an L-shaped bracket to connect wood panels at a right angle, a linear design for shelf formation, or may include legs for creating boxes with leg tables.

### REFERENCE TO RELATED APPLICATION

This application is related to and claims priority and a filing date of the Provisional Application bearing Application No. 62/070,704 and a filing date of Sep. 4, 2014.

### FIELD OF THE INVENTION

The present invention is a furniture and shelving system consisting of one or more wood panels and various embodiments of joint hardware. More specifically, the present furniture and shelving system features newly designed joint hardware each embodiment of which includes at least one pair of nearly parallel inner and outer panel-retaining plates to snugly position and secure the wood panels.

### BACKGROUND OF THE INVENTION

Furniture and shelving manufacture is a centuries-old art, and there are several ancient methods for securing wood panels to each other. There are two most commonly used methods. The first is using fasteners such as screws, nails, brackets, and the like, typically formed from metal. This is a tried and true method of attaching wood panels together because the joints tend to be strong. One disadvantage of this method is that the fasteners must be provided separately from the wood panels. Moreover, this is a difficult method of assembly for the end user. Instead, the furniture must be pre-assembled in the factory, and shipped fully assembled, thereby greatly increasing shipping costs. The second common method of furniture assembly is by employing age-old mortise and tenon technology. Again, one difficulty with this method is that the furniture must be pre-assembled at the factory and shipped fully assembled.

The objective of the present invention is to provide a furniture and shelving system that does not require assembly utilizing fasteners such as screws, nor does the present system employ mortise and tenon joints. As such, the present system is less costly to ship as it does not need to be shipped fully assembled. The present invention furniture and shelving system can be shipped disassembled, and easily fully assembled by the end user without the use of tools.

Other objectives, advantages and novel features, and further scope of applicability of the present invention will be set forth in the detailed description to follow, taken in conjunction with the accompanying drawings, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a system of furniture and shelving employing the new and non-obvious joint hardware disclosed. There are various embodiments of the present invention ranging from shelving which may include one of several coat hook designs, boxes, or tables which boxes and tables may have short or long legs. In each case, the particular shelf or furniture embodiment includes at least one, or a plurality of wood (or other such solid-surface) panels having pre-determined dimensions. The wood panel(s) has a predetermined thickness. In each case the wood panels are attached together, or to a wall, employing the joint hardware of this invention. The joint hardware includes a pair of metal plates which are nearly parallel to each other. The nearly parallel metal plates are separated by a predetermined distance which distance corresponds to the predetermined thickness of the wood panel(s). The joint hardware of this invention is provided in one of several embodiments including an L-shaped bracket to connect wood panels at a right angle, a linear design for shelf formation, or may include legs for creating boxes with leg tables. In each case, the joint hardware has a pair of nearly parallel panel-retaining plates. The furniture is assembled at home, by the end user, and in most cases with no tools, simply by inserting the wood panel(s) between the panel retaining plates and twisting, thereby retaining each panel firmly.

### BRIEF DESCRIPTION OF THE DRAWINGS

For a better understanding of the present invention, reference is made to the following description of an exemplary embodiment thereof, considered in conjunction with the accompanying drawings, in which:

FIG. 1A is depiction of the box embodiment of the present invention having short legs.

FIG. 2 is front perspective view of the table embodiment.

FIG. 3 is a front perspective view of the leg joint hardware of the box embodiment with short legs.

FIG. 4 is side view of the leg joint hardware of the box embodiment with short legs.

FIG. 5 is top view of the leg joint hardware of the box embodiment with short legs.

FIG. 6 is side view of the leg joint hardware of the box embodiment with short legs.

FIG. 7 is side view of the joint hardware of the box embodiment with long legs.

FIG. 8 is side view of the joint hardware of the box embodiment with long legs.

FIG. 9 is top view of the leg joint hardware of the box embodiment with long legs.

FIG. 10 is side view of the leg hardware of the box embodiment with long legs.

FIG. 11 is front view of the joint hardware of the table embodiment with short legs.

FIG. 12 is front view of the joint hardware of the table embodiment with short legs.

FIG. 13 is a bottom view of the joint hardware of the table embodiment.

FIG. 14 is front perspective view of the joint hardware of the table embodiment with long legs.

FIG. 15 is front view of the joint hardware of the table embodiment with long legs.

FIG. 16 is a bottom view of the joint hardware of the table embodiment with long legs.

FIG. 17 is a front perspective view of the top joint hardware of the box embodiment.

FIG. 18 is a front view of the top joint hardware of the box embodiment.

FIG. 19 is a front view of the top joint hardware of the box embodiment.

FIG. 20 is bottom view of the top joint hardware of the box embodiment.

FIG. 21 is a front perspective view of the joint hardware having a wall mount.

FIG. 22 is front view of the joint hardware having a wall mount.

FIG. 23 is back side view of the joint hardware having a wall mount.

FIG. 24 is front side view of the joint hardware having a wall mount.

FIG. 25 is front perspective view of the joint hardware in a cross configuration used to join panels perpendicularly.

FIG. 26 is top view of the joint hardware in a cross configuration used to join panels perpendicularly.

FIG. 27 is a front view of the joint hardware in a cross configuration used to join panels perpendicularly.

FIG. 28 is front perspective view of the joint hardware used to join panels in a t-shaped configuration.

FIG. 29 is top view of the joint hardware used to join panels in a t-shaped configuration.

FIG. 30 is front view of the joint hardware used to join panels in a t-shaped configuration.

FIG. 31 is a front view of the joint hardware of the shelf embodiment.

FIG. 32 is a side view of the joint hardware of the shelf embodiment.

FIG. 33 is a top view of the joint hardware of the shelf embodiment.

FIG. 34 is a back view of the joint hardware of the shelf embodiment.

FIG. 35 is a front perspective view of the shelf embodiment having a split coat hook.

FIG. 36 is a side view of the shelf embodiment having a split coat hook.

FIG. 37 is a front view of the shelf embodiment having a split coat hook.

FIG. 38 is a top view of the shelf embodiment having a split coat hook.

### DETAILED DESCRIPTION OF THE INVENTION

The present invention is a furniture and shelving system with various embodiments of new and non-obvious joint hardware that is employed to assemble the various articles of furniture and shelving.

All of the articles of the present furniture and shelving system include at least one wood panel as shown in the figures which panel or panels form the walls and/or shelving of the particular article provided. In each case, the wood panel or panels have a predetermined thickness or width which is critical to the proper installation of the joint hardware. (It is noted that although the figures show the panels and/or shelving as being formed from wood, the choice of wood is not critical, and they may also be made of plastic, particle board, metal or the like.)

Looking at the figures, central to each embodiment of the present invention furniture and shelving system is the new and non-obvious joint hardware that is utilized to connect together the one or more wood panels of the system. The joint hardware of the present invention system is formed from steel, however joint hardware made from other metals, plastic or other such rigid materials are within the scope of this disclosure. The steel hardware may be provided in a variety of colors and also in galvanized finishes, and metal finishes such a brass, copper, nickel, etc.

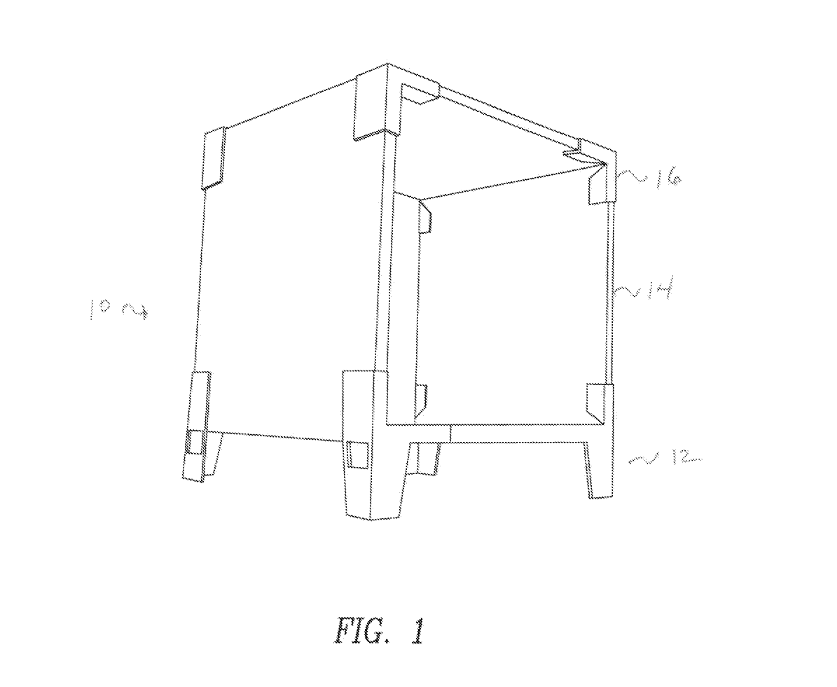

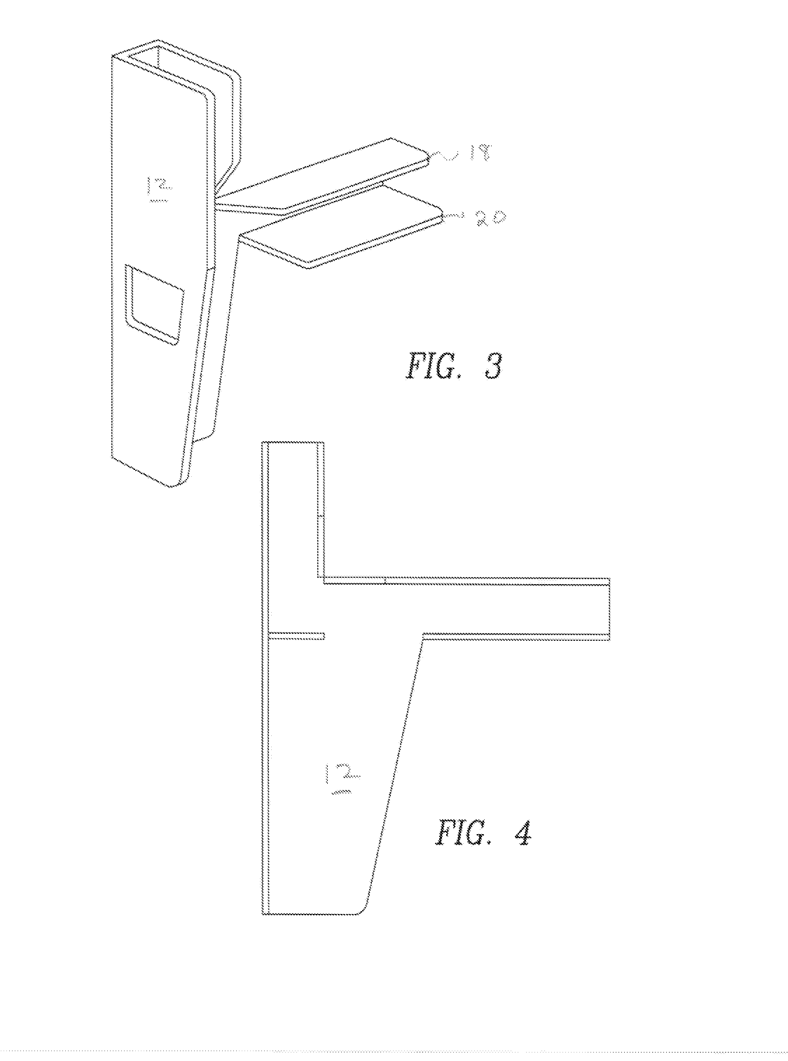

The first embodiment of the present invention system shown is in FIG. 1 which is the embodiment to form a storage box 10. Once assembled, the box of the present invention is very versatile. As depicted in FIG. 1, this embodiment of the storage box has legs 12 so it can be placed on the floor. A similar embodiment having no legs sits flush on any surface, and can be used for storage, as a night table, coffee table, end table or the like. In the case of the box embodiment, four wood panels 14 are provided along with eight units of the joint hardware 16 which when assembled, form a box a shown in FIG. 1. It is understood that at least two, if not all four of the wood panels are supplied in equal lengths and widths so that the corners will all be square when the box is fully assembled. Further, each of the four panels has a predetermined thickness, which is identical in all four panels. In the case of the box with no legs, the eight units of joint hardware 16 that form the corners are L-shaped. In the case of the box with legs as shown in FIG. 1 (short-leg box), the top four units are L-shaped, and the bottom four units have two L-shaped panel retaining plates and also include legs, as shown in FIGS. 3 and 4. Like all of the joint hardware of the present system, the corner hardware of the box embodiment has panel retaining plates for snugly retaining the wood panels. More specifically, in the box embodiment of this invention, each leg of the L-shaped corner bracket hardware includes a pair of panel retaining plates 18 and 20 for retaining the wood panels (FIGS. 3 and 4.) To be very specific, the predetermined thickness of each of the wood panels is chosen carefully so that each of the wood panels is snugly retained between the inner and outer plate of the corner joint hardware. One unit of the joint hardware is positioned on each of eight corners of the box. As such, in the box embodiment of this invention, four wood panels and eight units of joint hardware are supplied.

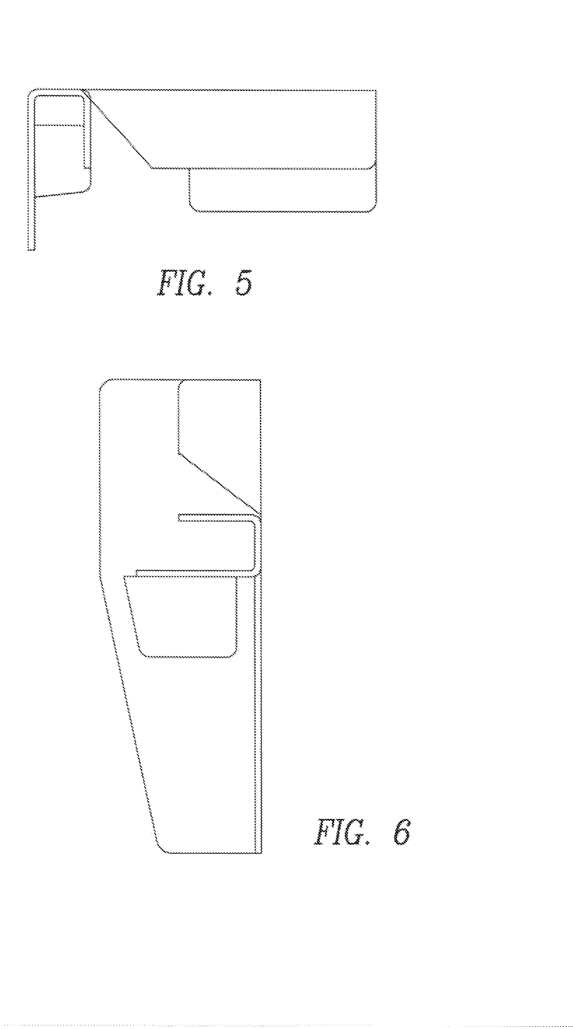

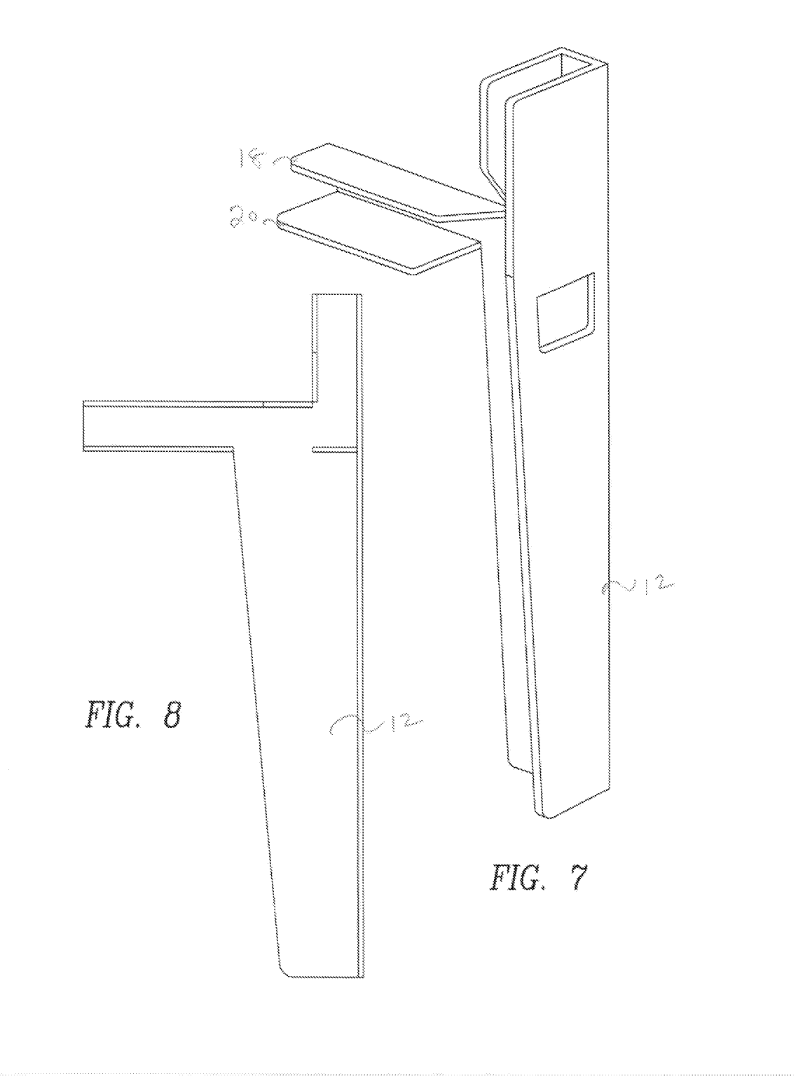

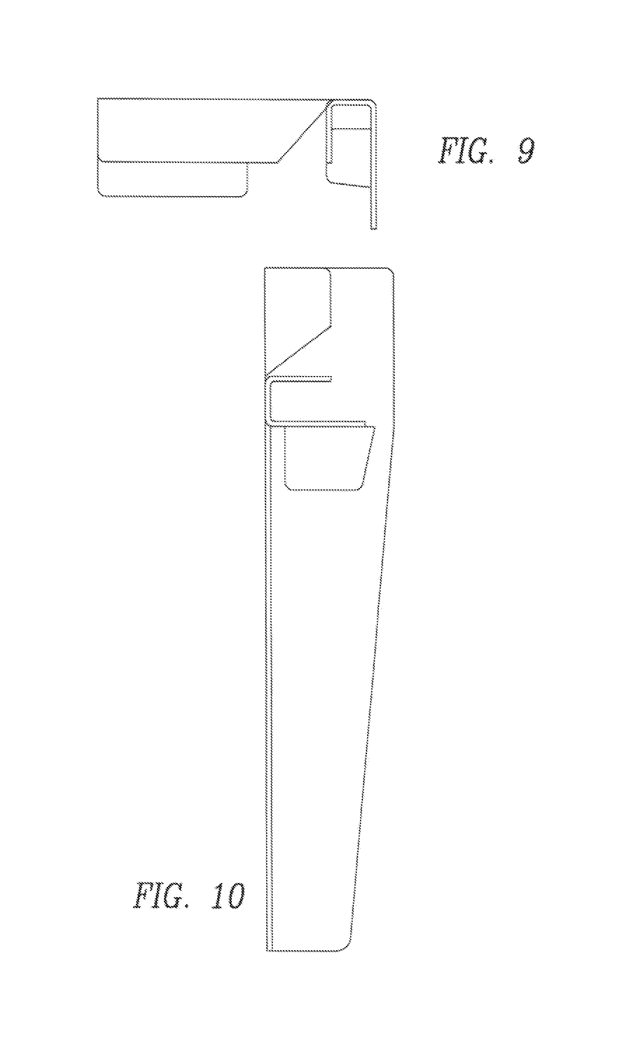

The joint hardware for the box embodiments having legs are shown in FIGS. 3 through 6 and FIGS. 7 through 10. The short-legged version has legs as shown in FIGS. 3 through 6. The long legged version has legs as shown in FIGS. 7 through 10. In each of these examples, a total of four wood panels and eight units of joint hardware are supplied. The four units of joint hardware that connect the top four corners are L-shaped, identical to the joint hardware the box embodiment disclosed previously. The four bottom units of the joint hardware for the box embodiment with legs have T-shaped joint hardware. More specifically, a pair of L-shaped panel retaining plates 18 and 20 for connecting the wood panels at the lower corners of the box is provided. Now, extending downward from the L-shaped corner connectors is a leg 12.

To form the storage box, the four wood panels are assembled corner to corner with each corner forming a right angle. The panels are connected together by inserting each of the four panels between the panel retaining plates of the corner hardware. Specifically, each panel is placed at an angle between the panel retaining plates and thereafter twisting into place such that it is parallel to the panel retaining plates and retained snugly between them.

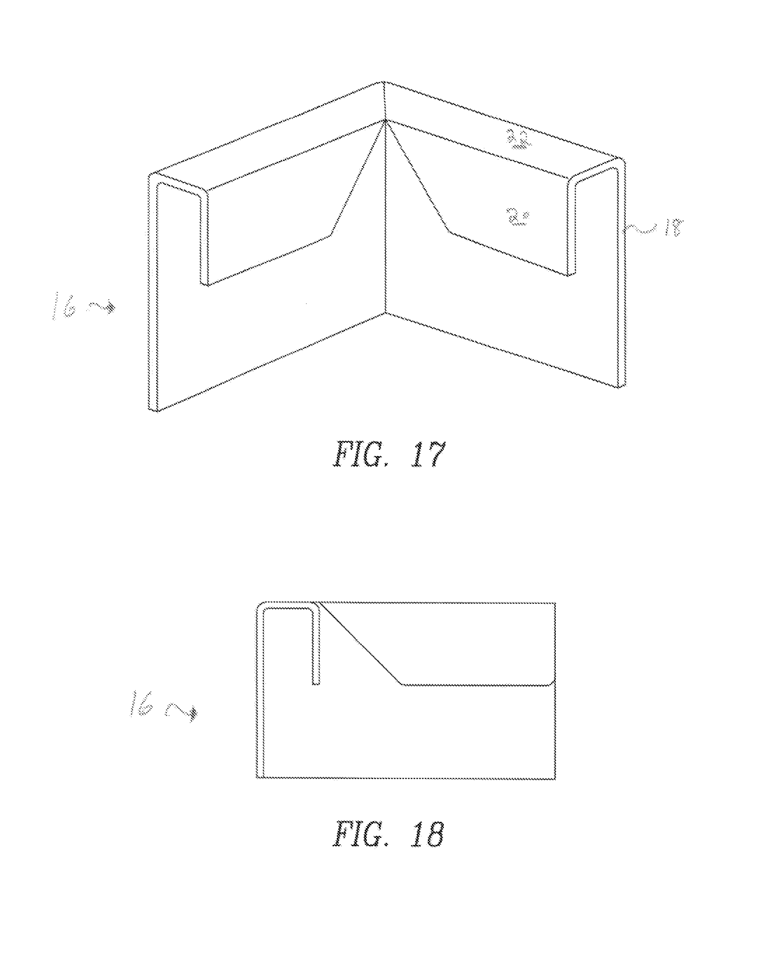

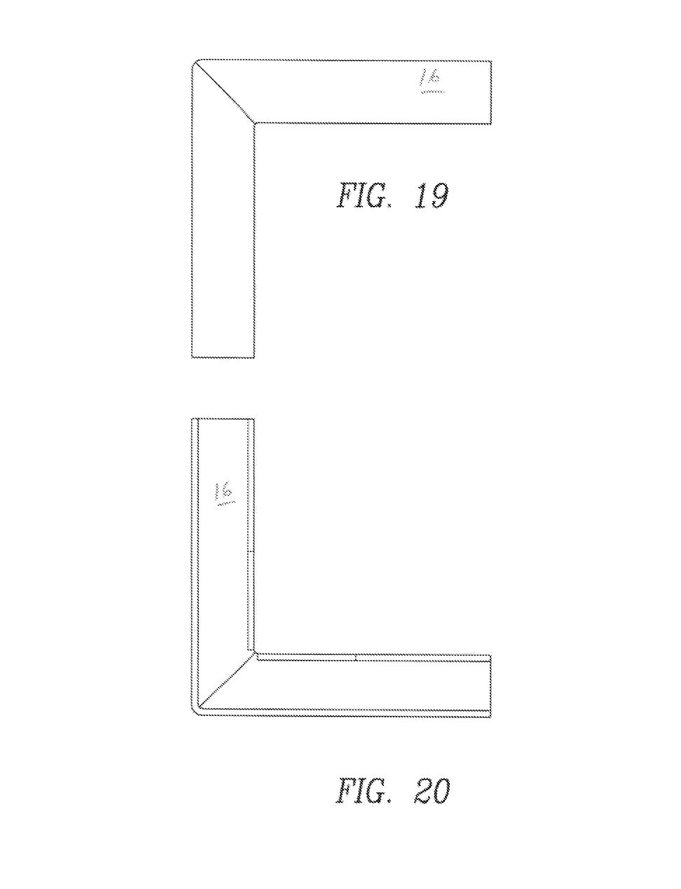

It is instructive to look very closely and to describe the top joint hardware for the box embodiment, which shares inventive aspects of all of the embodiments of the joint hardware of the present system. Looking at FIGS. 17 and 18, it can be seen that the top joint hardware 16 of the box is generally L-shaped, each leg of the L having a pair of panel retaining plates 18 and 20 for retaining a wood panel. The two panel retaining plates are substantially, but not perfectly, parallel to each other and are spaced apart from each other a predetermined distance, which predetermined distance corresponds to the thickness of the wood panel that is to be positioned between the plates. As such, when a shelving or furniture panel is positioned between the panel retaining plates, the panel is firmly and snugly held in place. A connecting plate 22 connects the two panel retaining plates to each other where the connecting plate is perpendicular to each of the panel retaining plates. The inner plate 20 of the joint hardware may extend a smaller distance from the perpendicular connecting plate than the outer plate 18. Moreover, the corners of the inner plate may be truncated to an angle, as seen in the figures.

Common to all of the panel retaining plates is that the fact that they are not perfectly parallel to each other. As seen, the higher of the two panel retaining plates slants very slightly downward so that the two plates are not perfectly parallel. In other words, the top-most of the two panel retaining plates does not create a perfectly perpendicular angle to the connecting plate. Instead, it is a degree or several degrees short of being perfectly perpendicular, and as such slopes down ever so slightly toward the bottom of the two panel connecting plates. This feature is important in the functionality of the present invention as it helps to insure a snug retention of the panel between the two plates.

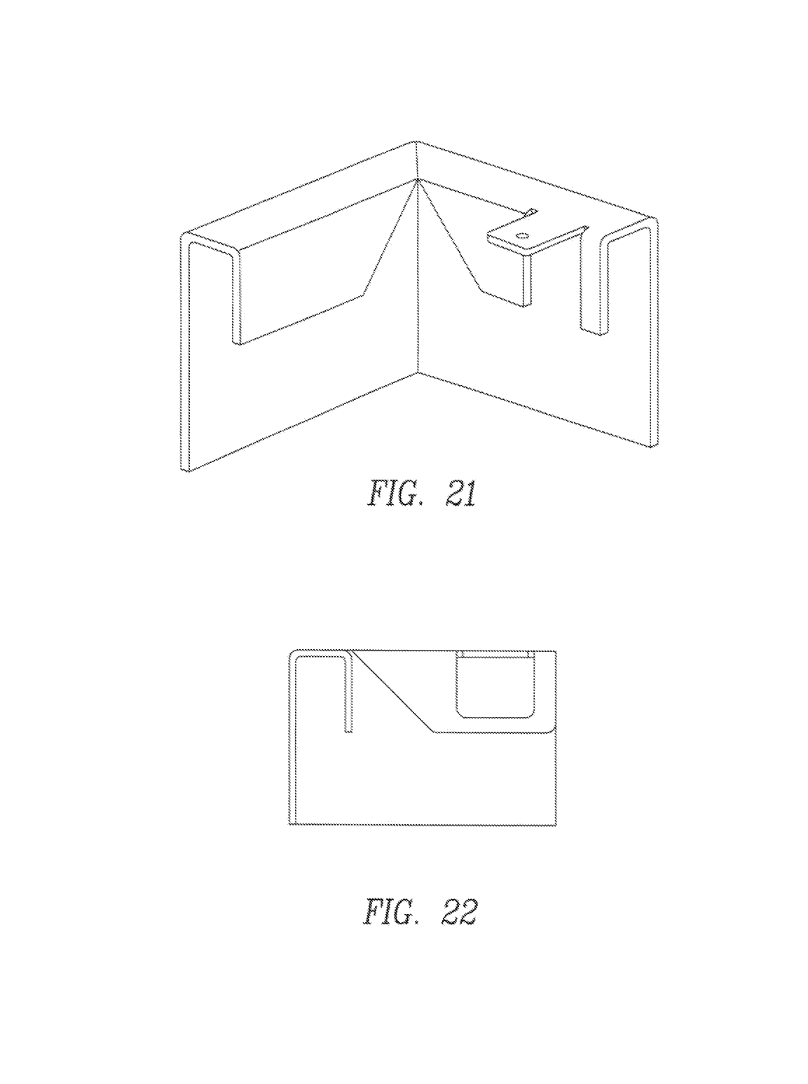

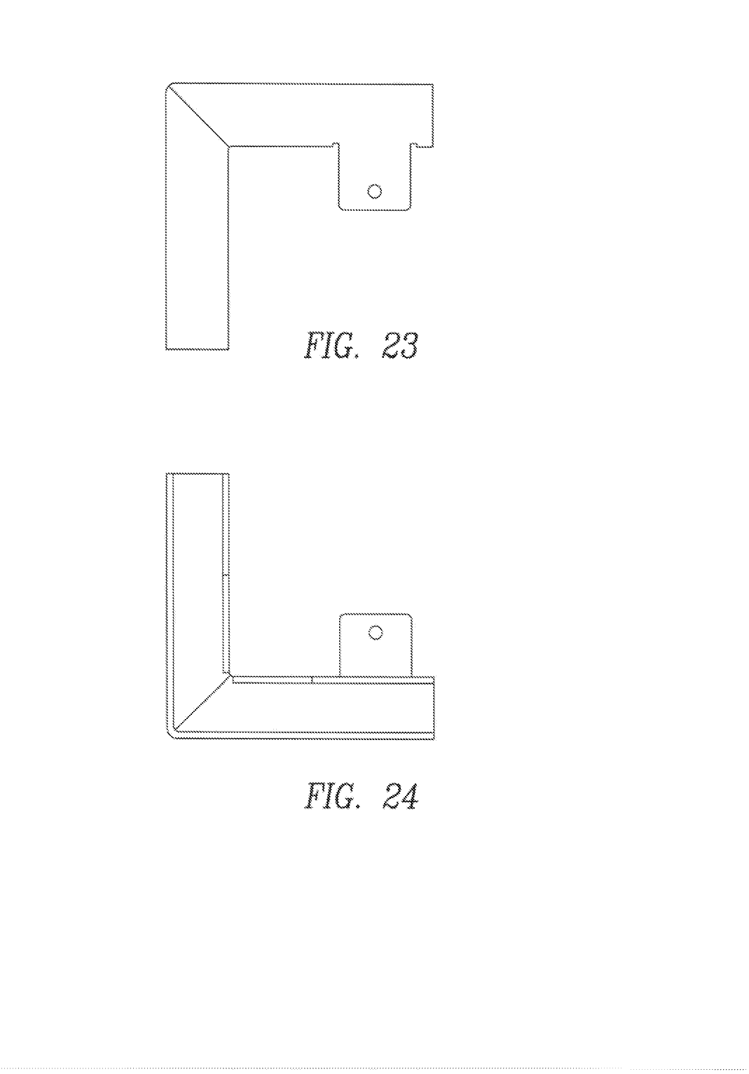

The box of the present invention may be wall mounted rather than floor standing. Looking at FIGS. 21 through 24, the corner hardware is shown in its configuration for wall mounting the box. In this configuration, a flange having a screw hole is extends outward from the inner of the two panel retaining plates.

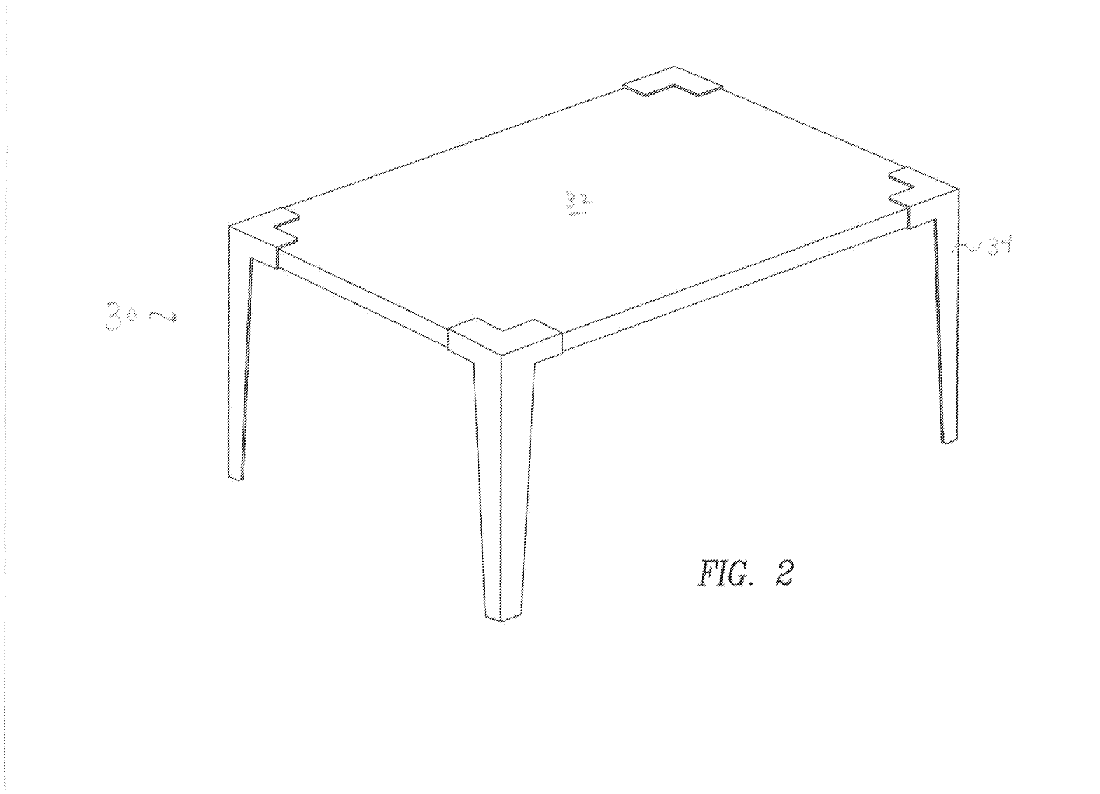

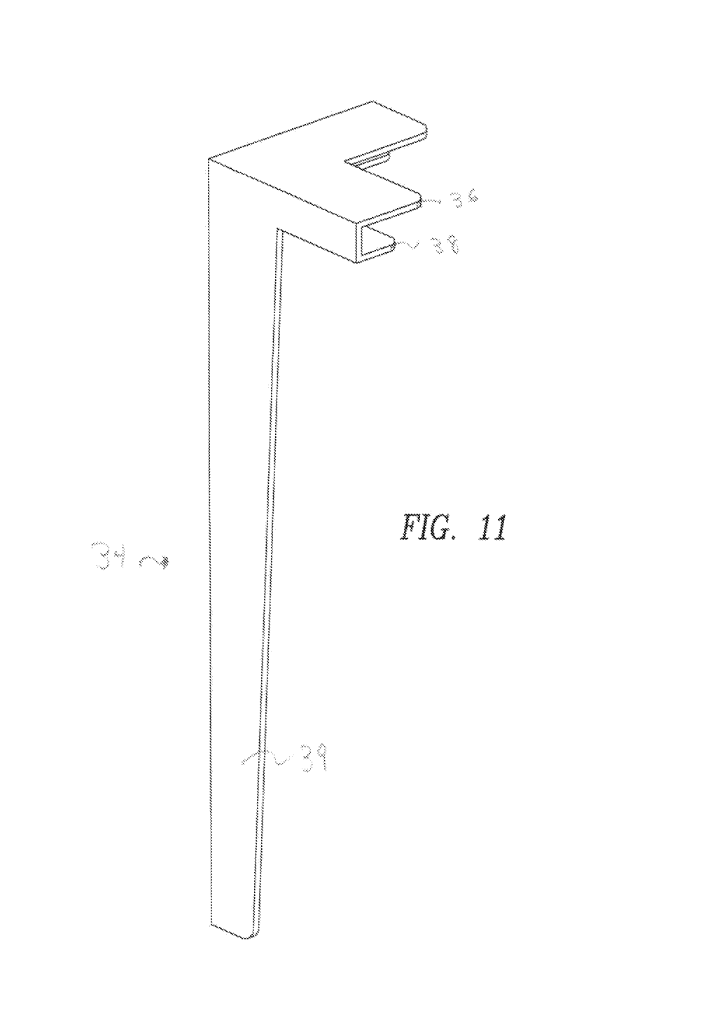

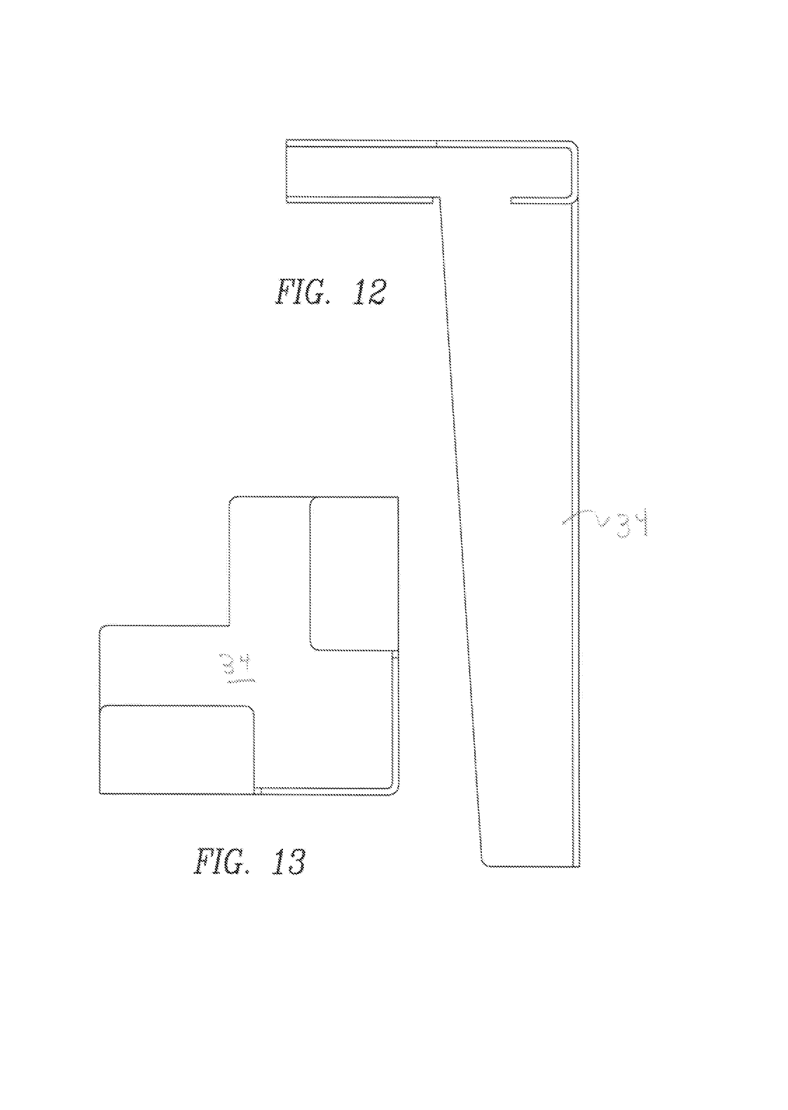

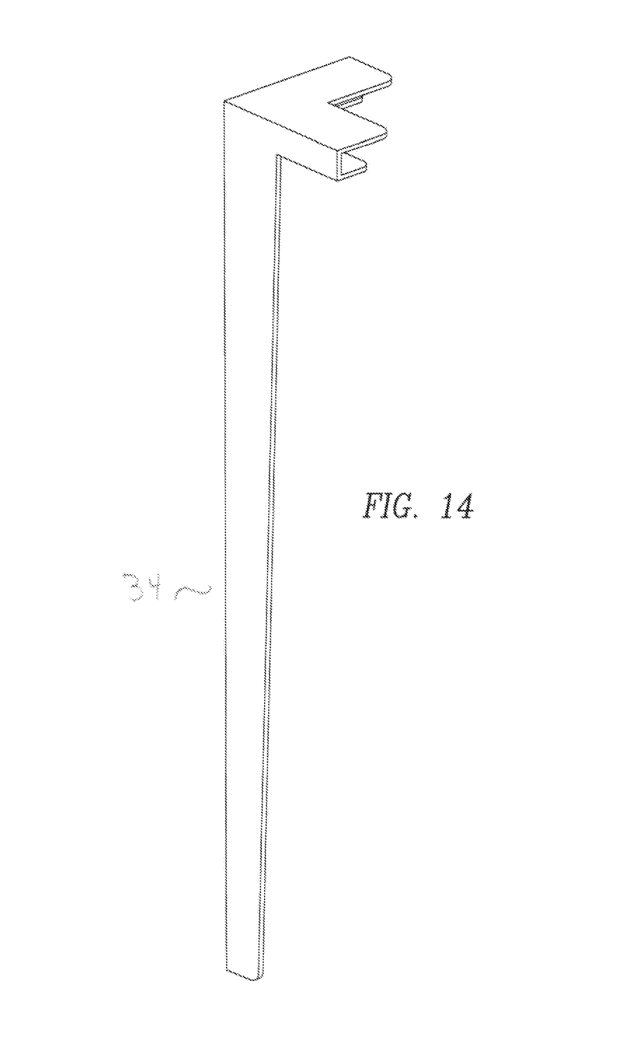

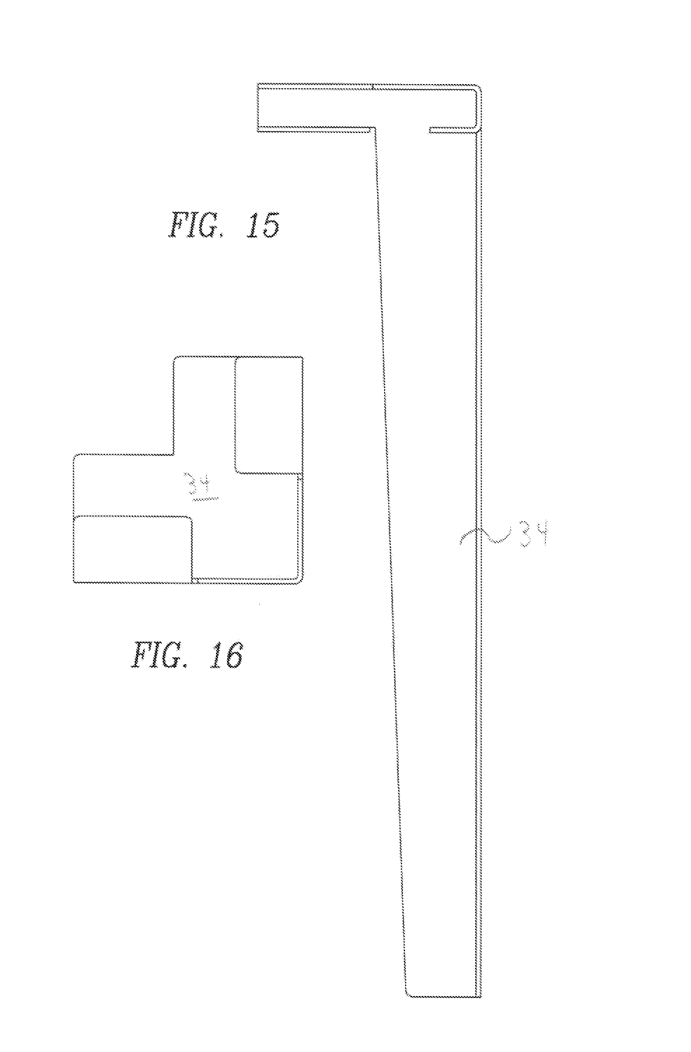

Now, looking at FIG. 2, the table embodiment 30 of the present invention is shown. In this case, one wood panel 32 is provided, along with four units of the joint hardware 34. The joint hardware, shown in FIGS. 11 through 16, has L-shaped panel retaining plates 36 and 38 which are employed to retain the wood panel which serves as the table top. A leg 39 extends downward from the L-shaped panel retaining plates. The leg may be shorter to provide a shorter coffee table or longer to provide an end table or the like. The embodiment with shorter legs is shown in FIGS. 11 through 13. The embodiment with longer legs is shown in FIGS. 14 through 16.

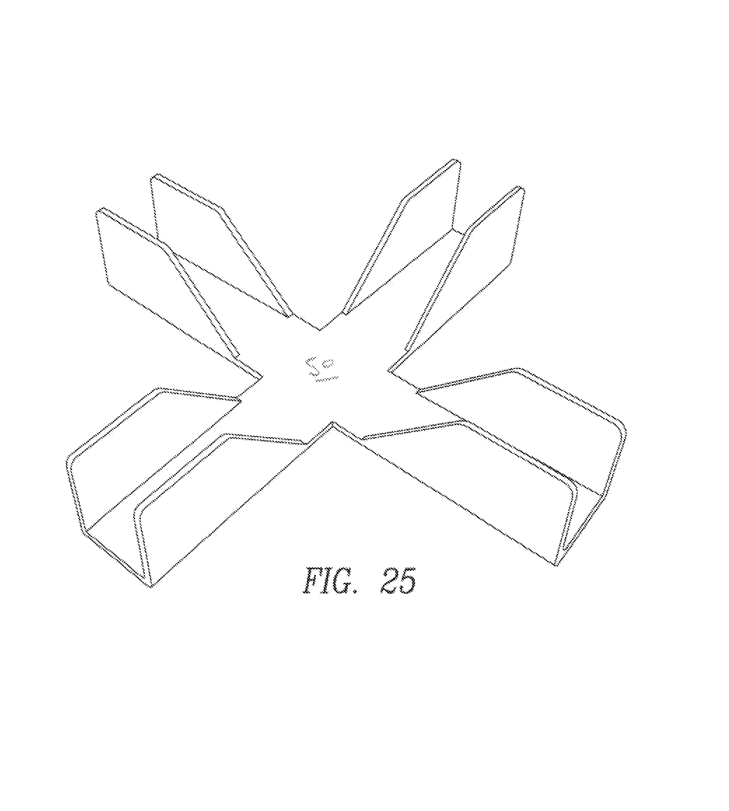

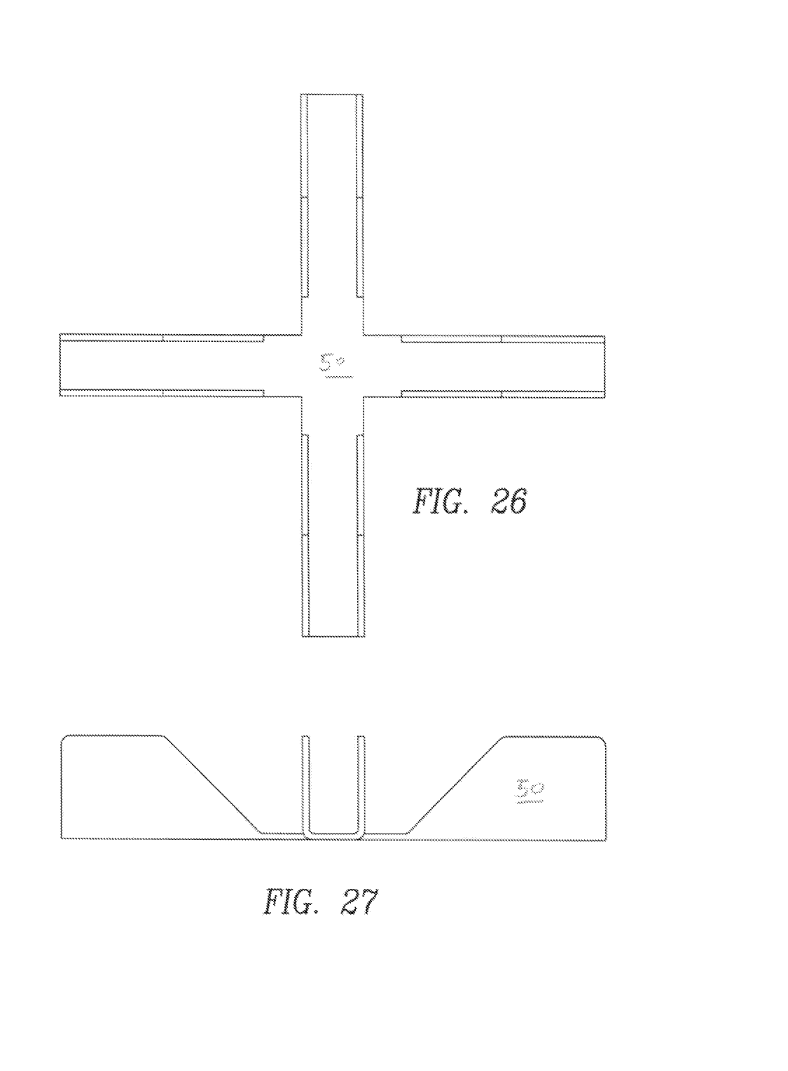

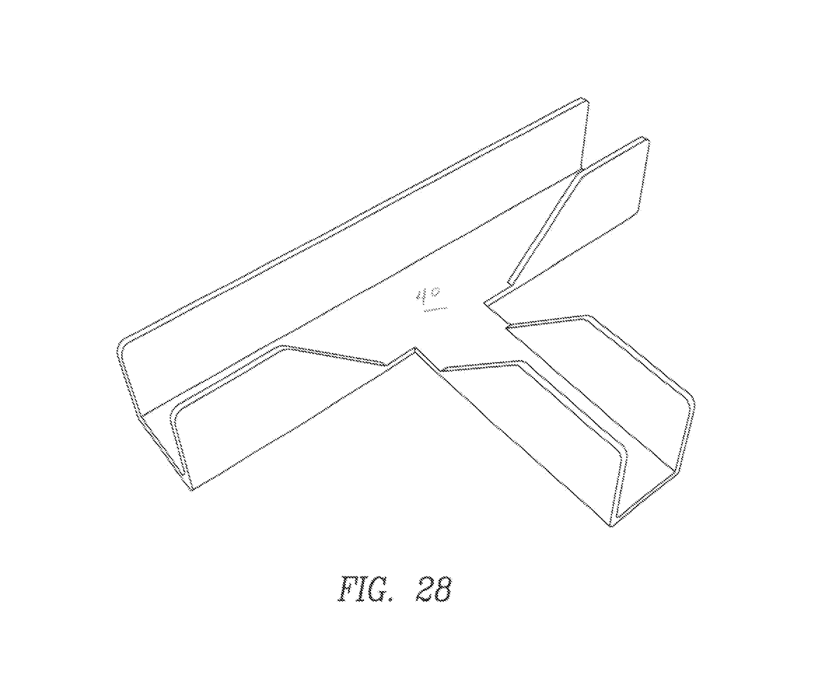

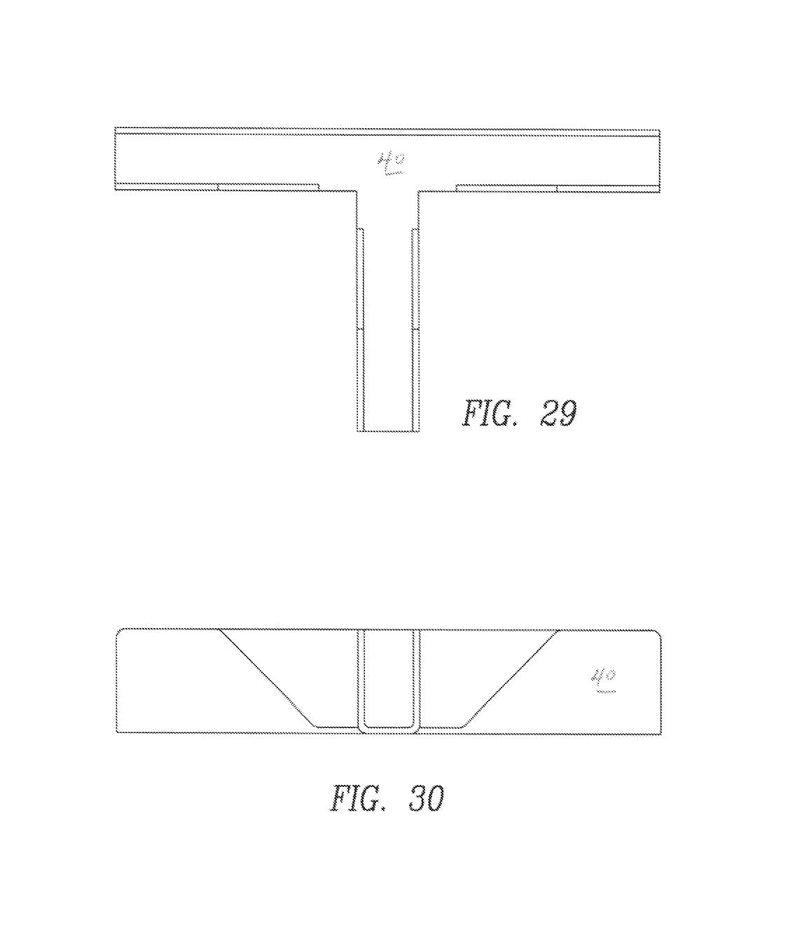

Two more embodiments of the joint hardware of the present invention are disclosed. One, as shown in FIGS. 28 through 30 is T-shaped 40 and is employed to unite two or three wood panels to each other at right angles. The panel retaining plates on the vertical leg are truncated to an angle. A second, as shown in FIGS. 25 through 27 is cross shaped 50, and is employed to join three or four wood panels to each other. The panel retaining plates are truncated to an angle.

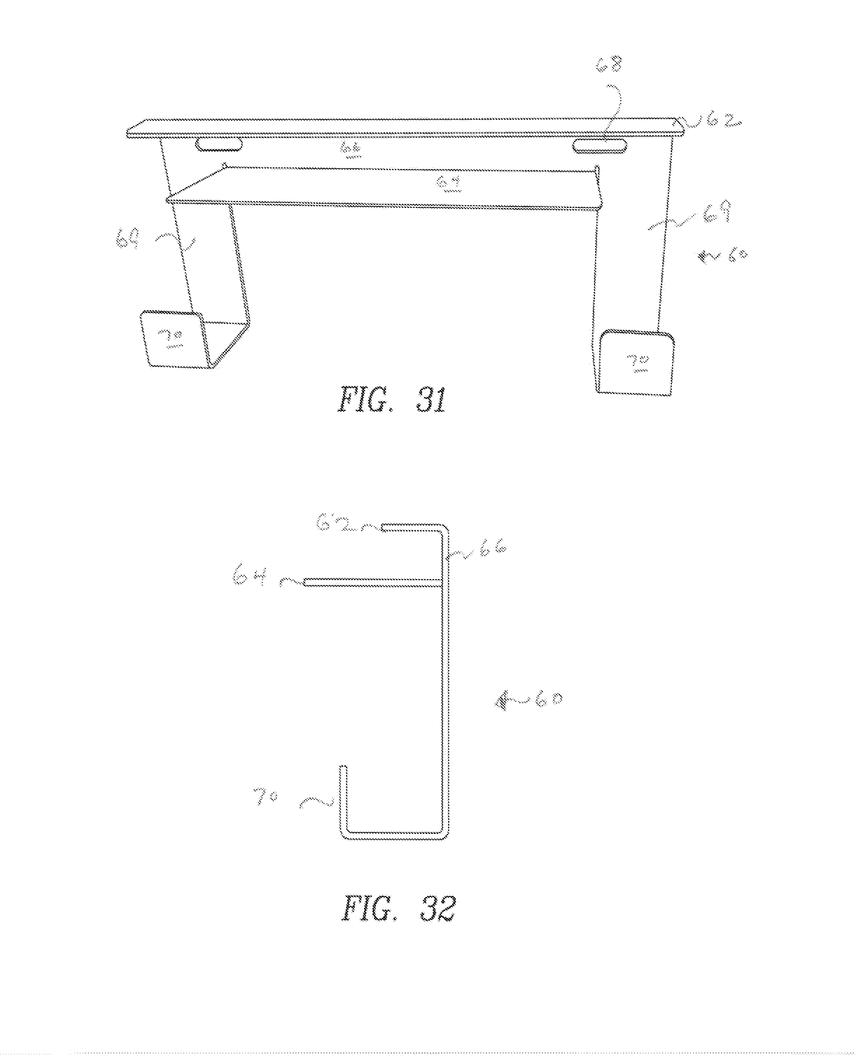

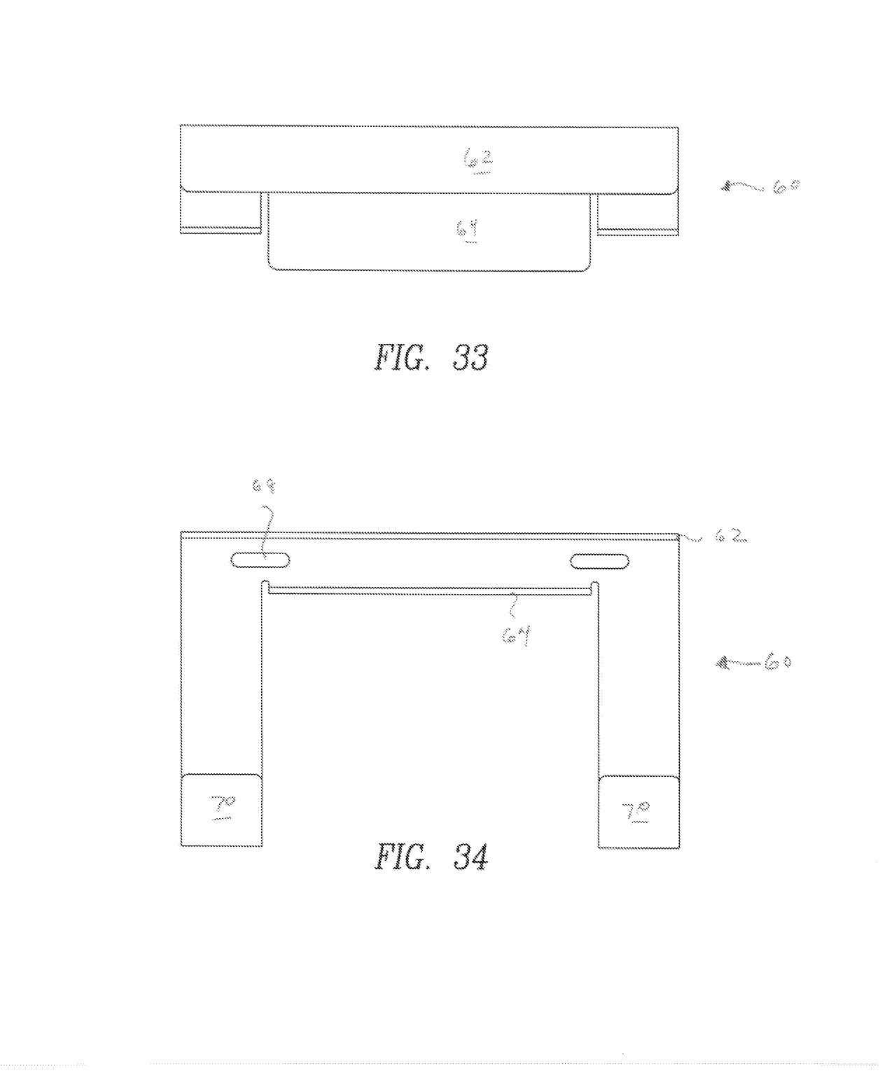

Now, attention is turned to FIGS. 31 through 34 which shows an embodiment of the present invention in its employment in a shelf configuration 60. The joint hardware in this shelf configuration is utilized to attach the wood panel to a wall thereby creating a shelf One or more units of the joint hardware for the shelf embodiment may be provided depending on the length of the chosen wood panel/shelf. Here, as in every embodiment of the invention, two panel retaining plates 62 and 64 which are used to retain the wood panel are provided. Formed into the connecting plate 66 which connects together the panel retaining plates are screw holes 68 for attaching the joint hardware to a wall. The connecting plate connects the two panel retaining plates. The bottom parallel plate 64 is shorter in length (but extends out further from the connecting plate 66) than the top parallel plate to facilitate formation of the downward extension plates 69. Each of the downward extension plates extends downward from the connecting plate, as shown in the figures. Furthermore, the each of the downward extension plates bends at a 90° angle and then again at another 90° angle to create the coat hooks 70. As in every embodiment of this invention, a wood panel is provided with a predetermined thickness corresponding to the distance between the two panel retaining plates, the wood panel here providing a shelf once this joint hardware is screwed to a wall.

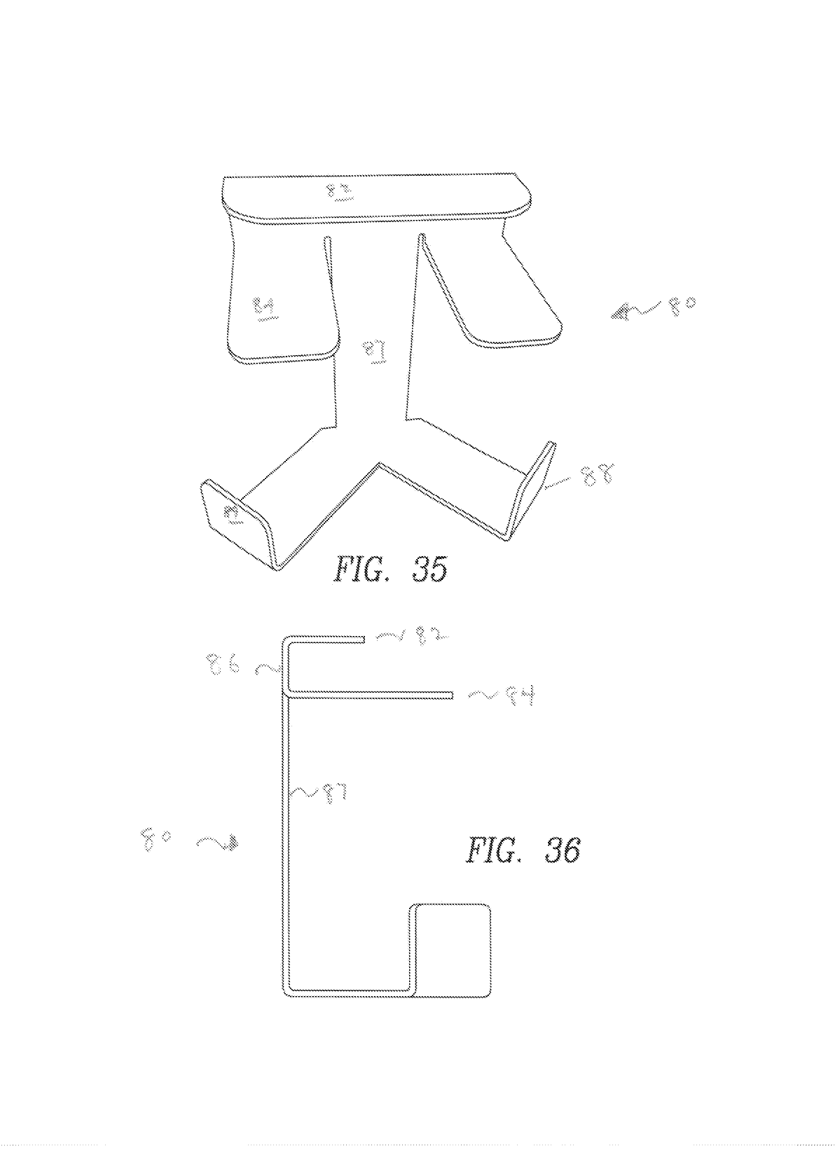

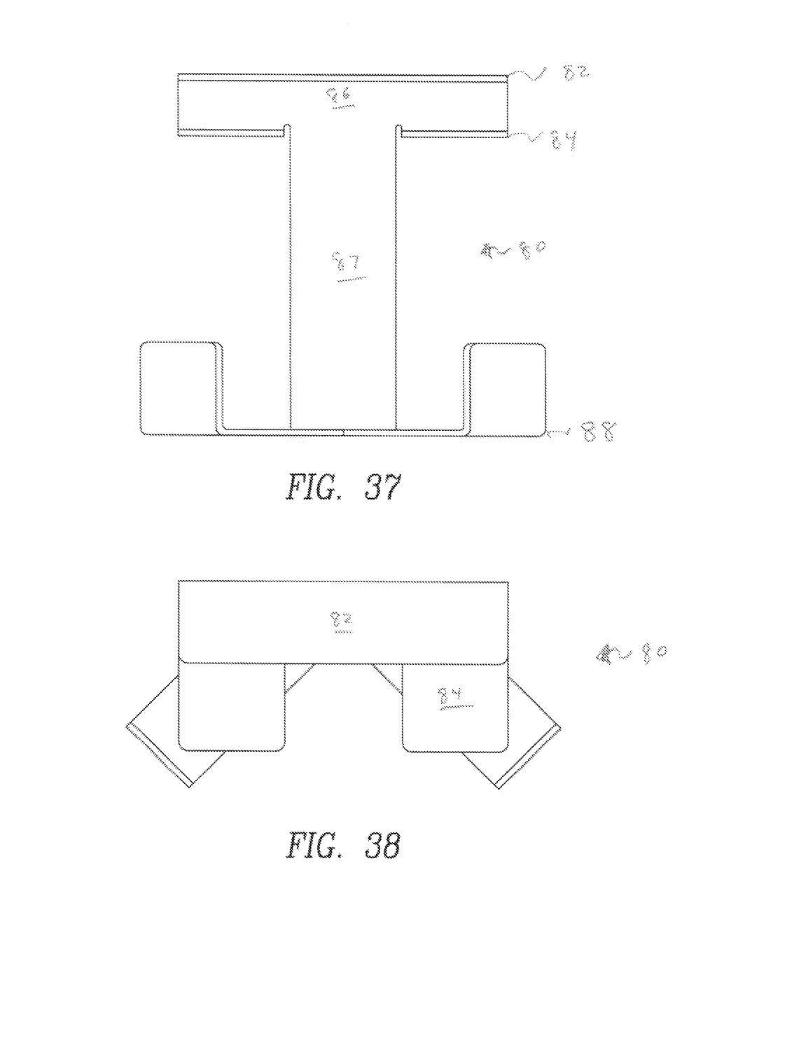

Another embodiment of the shelf joint hardware 80 is shown in FIGS. 35 through 38. As with all of the hardware in this system, two panel retaining plates 82 and 84 are provided. Here, the bottom of the two panel retaining plates is divided into two parts. Extending downward from the connecting plate 86 is the extension plate 87, which is perpendicular to the panel retaining plates. At 88, two horizontal plates are bent upward at 90° up from the connecting plate and extend outward at approximately a 45° angle. Each of this is now bent upward again at 90° thereby forming two coat hooks 89, 45° apart from each other. The shelf embodiment may be used in addition to, and as an accessory to, all of the other embodiments of the present invention.

In each embodiment of the present invention system, at least one pair of wood panel retaining plates is present. The two plates in the pair are always separated apart by a predetermined distance which distance corresponds to the thickness of the wood panel that will be snugly retained. In every case, the two panel retaining plates are almost, but not perfectly, parallel to each other as well described previously.

Common to each of the embodiments is the ease of assembly. In most cases, no tools are required for assembly. To assemble, the user merely places a wood panel between the pair of panel retaining plates of the joint hardware at an angle. Then the panel is secured between the plates with a twist and a push of the wood panel. Because the distance between the pair of plates is carefully chosen to correspond to the thickness of the wood panel, the wood panel is snugly secured between them.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

1. A table, said table comprising:
a panel that serves as a tabletop, said panel having a predetermined thickness;
four units of joint hardware for placement at each of the four corners of the table, each of said units of joint hardware having a first and a second L-shaped panel retaining plate, said panel retaining plates separated by a predetermined distance which predetermined distance is equivalent to said predetermined thickness of said panel, each of the pair of panel retaining plates connected to the other panel retaining plate by a connecting plate, where the first panel retaining plates slopes slightly toward the second panel retaining plate so that they are not perfectly parallel to each other;
each of said units of joint hardware having a leg that extends downward from the retaining plates,
wherein said panel is secured between the said panel retaining plates of joint hardware by positioning the panel at an angle between the panel retaining plates and twisting the panel into position between the parallel panels and parallel thereto.

2. A storage box, comprising:
four panels, each of the four panels having an identical predetermined thickness, said panels positioned corner to corner to form a box with each corner being a right angle;
eight units of joint hardware for placement at each of the four corners of the storage box, each of said units of joint hardware having a pair of first and a second panel retaining plates, said pair of first and second panel retaining plates being L-shaped, said first and second panel retaining plates separated by a predetermined distance, which predetermined distance is equivalent to said predetermined thickness of said four panels, each of the pair of panel retaining plates connected to the other panel retaining plate by a connecting plate, wherein the first panel retaining plate slopes slightly toward the second panel retaining plate so that they are not perfectly parallel to each other;
wherein each of said four panels is secured between the said panel retaining plates of joint hardware by positioning the panel at an angle between the panel retaining plates and twisting the panel into position between the panel retaining plates and parallel thereto.

3. The storage box of claim 2 wherein four of the units of joint hardware for placement at the bottom of the box include downward extending legs.

4. A furniture and shelving system comprising:
at least one panel, said panel having a predetermined thickness;
a pair of panel retaining plates, wherein the first panel retaining plates slopes slightly toward the second panel retaining plate so that they are not perfectly parallel to each other, said plates separated apart by a predetermined distance, which predetermined distance is equivalent to said predetermined thickness of said panel, said panel retaining plates utilized to retain said panel;
